(19) United States
(12) Patent Application Publication
(10) Pub. No.: US 2023/0045611 A1
(43) Pub. Date: Feb. 9, 2023

(54) Method for dynamic traffic routing of external transportation means in a high-bay warehouse

(71) Applicant: AMOVA GmbH, Hilchenbach (DE)

(72) Inventors: Ronald Johannes VAN DER MEER, The Walk Dubai (AE); Patrick BOL, Dubai (AE); Volker BRÜCK, Mudersbach (DE); Carsten HEIDE, Netphen (DE); Bernd KLEIN, Hilchenbach (DE)

(73) Assignee: AMOVA GmbH, Hilchenbach (DE)

(21) Appl. No.: 17/785,375

(22) PCT Filed: Nov. 9, 2020
(86) PCT No.: PCT/EP2020/081478

§ 371 Date: Jun. 14, 2022

(30) Foreign Application Priority Data
Dec. 16, 2019 (DE) 10 2019 134 528.6

(51) Int. Cl. B65G 1/137

(52) U.S. Cl. CPC B65G 1/1375

(57) ABSTRACT

The disclosure relates to a method for traffic routing of transportation means in a high-bay warehouse, comprising at least two storage levels, at least one level of transport with at least one option for a transportation means for accessing and/or leaving the level of transport.

### TECHNICAL FIELD

The disclosure relates to a method for dynamic traffic routing of external transportation means in a high-bay warehouse, comprising at least two storage levels, at least one level of transport with at least one access point for a transportation means for accessing and/or leaving said level.

### BACKGROUND

For the transfer of standardized storage goods between different external means of transport, in particular when transshipping from sea to land transport means, it is necessary to decouple the different flows of storage goods from each other and, if necessary, to store the standardized storage goods for a short period of time. Warehouses, in particular high-bay warehouses with corresponding internal warehouse transport devices, are typically used for this purpose. Different external transportation means lead the standardized storage goods to and from the high-bay warehouse. For this purpose, autonomous external driving transportation means as well as person-operated external transportation means may be used.

The transfer of standardized storage goods from an external transportation means to the internal warehouse transport system takes place at a transfer point that is structurally defined in advance. Typically, the transfer location is to be reached along a structurally defined travel path by the external transportation means. The transfer points are usually located at one or two outer edges of the high-bay warehouse and the transfer takes place at such interfaces by means of an intermediate transshipment facility. The cost efficiency of the transfer process from the external transportation means to the storage location depends on the time required for the individual steps performed in the process to transfer the standardized storage goods. With the current increase in sea-going vessel capacity and limited space in existing seaports, there is a need to further reduce transfer times and thus further increase cost effectiveness.

Until now, the achievable transfer time has been determined by the traffic flow of the external transportation means to the transfer point, the distribution of the transfer points at the outer edges of the high-bay warehouse and the travel times of the internal warehouse transport system between the transfer point and the storage location.

### SUMMARY

An object of the disclosure is to optimize the traffic flow of the external transportation means and the interaction between the external transportation means and the internal warehouse transport system in such a way that the transfer times are reduced.

The object is achieved by the features of the method as claimed. Each transfer point in the level of transport can be reached by the external transportation means along a travel path. The dynamic determination of the travel path of the external transportation means in the level of transport, a point of time for loading or unloading and the assignment of a transfer point are adjusted depending on the parameters relevant for the operation of a warehouse. In the concept in accordance with the invention, “travel path” means that an external transportation means within the level of transport can reach or leave the transfer point in the level of transport by means of the travel path. In accordance with the invention, the travel path can also connect two transfer points and does not necessarily always have to include the outer edge. The dynamic definition of a travel path also includes the temporary blocking of traversable areas of the level of transport for a single external transportation means and/or for a plurality of external transportation means. This is particularly important if possible travel paths in the level of transport of different types of external transportation means are to be or have to be separated from each other for a limited period of time, for example for safety reasons. This can preferably be done by barriers, optical signals, gates, movable fences and/or the like. The parameters relevant for the operation of a warehouse are, for example, specifications for the storage of the standardized storage goods, in particular safety specifications and/or necessary power connections, or specifications for onward transport to external recipients. Given that the travel paths within the level of transport are variable, more travel paths can be used in parallel independently of each other for external transportation means, and congestion is avoided. Furthermore, no additional transshipment operations are necessary here at the outer edges of the high-bay warehouse. The transfer time is reduced and/or the number of transfer operations within a period of time is thus increased. The fact that the transfer point can vary almost freely in the level of transport means that the distance of the internal warehouse transport means between the transfer point and the storage location of the standardized storage goods can be shortened.

Preferably, a transportation means is loaded or unloaded at more than 8, more preferably at more than 16, even more preferably at more than 32 transfer points in the level of transport. As the number of transfer points or transfer areas in which a transfer can take place increases, the number of parallel transfer operations increases and the individual transfer time for a standardized storage good decreases as a result.

Preferably, a transportation means can be loaded or unloaded at more than 8, more preferably at more than 16, even more preferably at more than 32 transfer points along an aisle of a transport system in the level of transport. As the number of transfer points within an aisle of a transport system increases, the paths of the transport system can be shortened. This makes it possible to guide an external transportation means precisely to a transfer point at which the path of the transport system is short.

The travel path is preferably not substantially limited by structural features within the level of transport that cannot be changed. Structural devices for traffic management, such as barriers, gates, movable barriers, optical signal transmitters, or the like, are not considered to be structural feature that cannot be changed. Structural features that, due to the design of the high-bay warehouse and/or for reasons of building codes, restrict the travel paths within the traffic paths should be reduced to a minimum. The advantage here results from the fact that there should be a maximum of possible travel paths for the external transportation means to reach a transfer point, and the travel path can thus be freely adjusted.

The standardized storage goods are preferably containers, even more preferably sea containers, most preferably 20-foot sea containers and/or 40-foot sea containers. The use of such containers is preferred because it allows the corresponding attachment operations on the crane or securing operations on the transporting external transportation means to be automated.

Ideally, the level of transport for loading or unloading the standardized storage goods is traversed by at least two different types of external transportation means, preferably trucks, autonomously driving tractors and/or rail-bound transportation means. Both external transportation means can move freely within a level of transport with essentially no restrictions. In such a case, both external transportation means represent typical external transportation means in the field of warehouse logistics of large high-bay warehouses.

Furthermore, it is preferred if an alignment of the standardized storage goods on the external transportation means is taken into account when loading the standardized storage goods when determining the travel path of the external transportation means in the level of transport. In particular, when loading trucks that traverse in public areas, it is necessary for safety reasons to take into account, for example, the position of a loading opening of a container. Furthermore, in the case of coils or similar storage goods, the alignment must be taken into account in accordance with the load securing options available on the transportation means.

Ideally, the travel path, the point in time for loading or unloading and/or the transfer point are determined by a open-loop or closed-loop control system. The open-loop or closed-loop control system has at least one algorithm that, on the basis of previously defined target variables, determines specifications of the parameters relevant for the operation of a warehouse, the travel path, the point in time for loading or unloading and/or the transfer point. This means that the processes and specifications can be dynamically adjusted to requirements and/or changing conditions. This is particularly advantageous if external influences, such as delays in the inflow of storage goods and/or short-term call-offs of standardized storage goods, interfere with the normally regulated transfer of standardized storage goods. With the algorithm, preferably an algorithm with optimization, the method can dynamically improve the process. As target variables for optimization by the algorithm, a handling time, utilization of the high-bay warehouse, traffic volume, distribution of traffic flows, distribution of transportation means, utilization of traffic areas, utilization of the internal warehouse transport system, warehouse strategy, malfunction situations and/or maintenance can preferably be determined and/or optimized. As the parameters relevant for the operation of a warehouse, the algorithm preferably uses a traffic volume, distribution of traffic flows, distribution of transportation means, utilization of traffic areas, utilization of the internal warehouse transport system, warehouse strategy, malfunction situations and/or maintenance.

Furthermore, it is preferred that the open-loop and/or closed-loop control system exchanges data with the external transportation means, preferably location, speed, travel path, the point in time of loading or unloading and/or the transfer point. The more extensive the communication between the open-loop or closed-loop control system and the external transportation means, the more accurately and better the open-loop or closed-loop control system can react to possible deviations. Thereby, it is also preferred if the open-loop or closed-loop control system uses interfaces to a higher-level control system, preferably a higher-level control system of a seaport, and a data exchange takes place between the systems, preferably of the target variables and/or the relevant parameters. This also has the advantage that the internal warehouse control system of the high-bay warehouse and the associated optimization can be adjusted to external conditions of a higher-level logistics or goods flow. In particular in the area of seaports, time delays can occur, which delays are significantly greater than time delays for transfer by means of truck. By means of a suitable interface to a higher-level open-loop or closed-loop control system, the open-loop or closed-loop control system of the high-bay warehouse can react to this and adjust the traffic routing.

It is preferred that the xy coordinate system used to describe the transfer points within the level of transport covers at least 60%, preferably at least 80%, even more preferably at least 90% of the level of transport. The use of an xy coordinate system makes it easy to divide a level of transport into a comprehensible structure. The travel path of an external transportation means to a transfer point or away from a transfer point is preferably described by a sequence of xy coordinates, preferably GPS coordinates. In this manner, even a very complex travel path can be easily described by means of a sequence of points. Such a description of a travel path can, by means of existing technologies, both be processed by autonomously driving external transportation means as well as transmitted to manually operated external transportation means. In conjunction with suitable navigation software and/or navigation systems, the travel path can be displayed to an operator of an external transportation means and guide such person to the transfer point. For this purpose, for example, GPS coordinates or modified GPS coordinates can be transmitted to the navigation system of the manual transportation means.

Furthermore, it is preferred if the travel path of a transportation means to a transfer point or away from a transfer point is described by a sequence of xy coordinates and further specifications, preferably points in time or time spans. By combining path and time as specifications, targeted stopping points, stopping times can be used to avoid congestion. This can increase the throughput of external means of transport without the risk of congestion.

Preferably, switchable means are used within the level of transport to indicate and/or restrict at least one travel path for the external transportation means. Particularly in the case of simultaneous operation of autonomously and manually operated external transportation means within a level of transport, this makes it easy to separate or safeguard the travel paths.

### BRIEF DESCRIPTION OF THE DRAWINGS

The description is accompanied by the following three figures:

FIG. 1: Side view of a high-bay warehouse.

FIG. 2: Top view of a level of transport.

FIG. 3: Open-loop/closed-loop control systematics of the high-bay warehouse

### DETAILED DESCRIPTION

The invention is described in detail below with reference to the above figures. In all figures the same technical elements have the same reference signs.

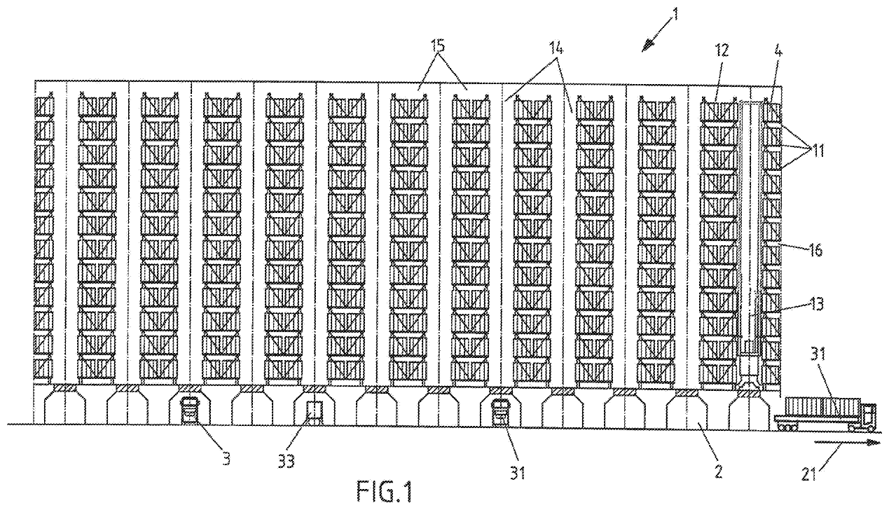

FIG. 1 shows a section through a high-bay warehouse 1 with a level of transport 2 and twelve storage levels 11 above it. Twenty-four different internal warehouse transport systems 13 move the standardized storage goods 4 within the high-bay warehouse 1 in warehouse aisles 14 along the storage rows 15 of the high-bay warehouse 16 to a specific storage location 12 of the standardized storage goods 4 in the high-bay rack 16.

Furthermore, the internal warehouse transport systems 13 can acquire or transfer a standardized storage good 4 below the storage levels 11 from an external transportation means 3 traveling on the level of transport 2. In the example shown, the high-bay warehouse 1 is designed to transfer standardized sea containers.

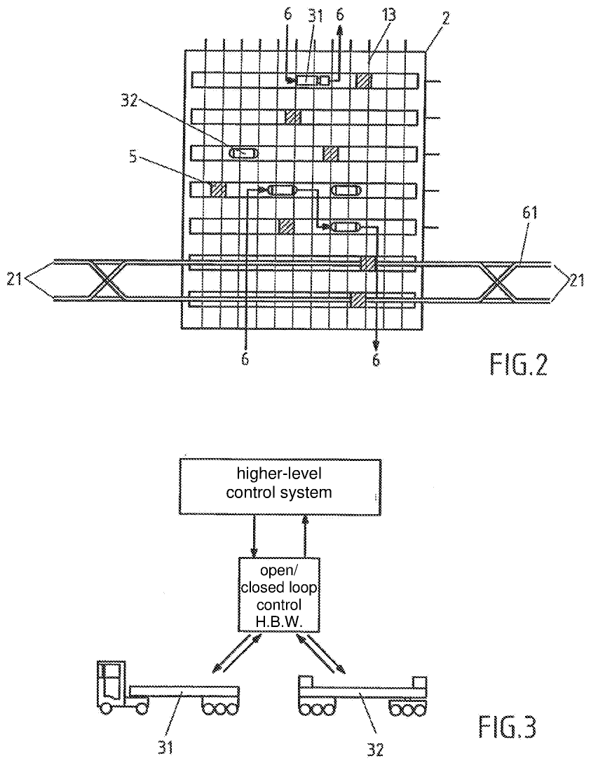

FIG. 2 shows a top view of a level of transport 2 below a high-bay warehouse 1. In warehouse aisles 14 of internal warehouse transport systems 13 running parallel to each other, standardized storage goods 4 can be transferred to the external transportation means 3. Thereby, the transfer point 5 can be varied substantially freely within the warehouse aisle 14. This creates a large number of possible transfer points 5 in the warehouse aisle 14. Arrows indicate possible travel paths 6 of an external transportation means 3 towards a transfer point 5. Analogously, the departure path 6 of the external transportation means 3 is shown. In such a case, in addition to being traversed by trucks 31 or autonomously driving tractors 32, a warehouse aisle 14 is shown, which aisle can be accessed by a rail-bound transportation means 33 or transport means. Thereby, the rail 61 is aligned in such a way that the rail 61 runs along the warehouse aisle 14. In this manner, it is possible for the rail-bound transportation means 33 to reach a plurality of transfer points 5 within a warehouse aisle 14. Likewise, it can be seen here that trucks 3 have a preferred orientation when loading.

FIG. 3 shows a schematic illustration of the open-loop and closed-loop control systematics of the open-loop or closed-loop control system of the high-bay warehouse 1. A higher-level control system transfers data to the open-loop or closed-loop control system of the high-bay warehouse 1 by means of an interface. An optimization algorithm within the open-loop and closed-loop control system processes such data and transfers it to the higher-level system, on the one hand, and to the external transportation means 3, on the other hand. The trucks 31 are given the corresponding entrance options 21, GPS coordinates of the transfer point 5 and the travel path 6, a transfer time. Beyond this, stopping times within the high-bay warehouse 1 and a speed are transmitted to an autonomously driving tractor 32. The open-loop or closed-loop control system receives back from the truck 31 the information regarding the location and reaching of the transfer point 5 or the entering and leaving of the level of transport 2. The internal warehouse transport system 13 reports, for example, the transfer of the standardized storage goods 4 to the external transportation means 3 to the open-loop or closed-loop control system. In addition to the data mentioned above, the autonomously driving transportation means 32 additionally transmits data describing the autonomous transportation means 32 with respect to the environment of the high-bay warehouse 1. For example, this can be a loading condition, a location outside of high-bay warehouse 1, a speed, an availability and/or a tank capacity.

DESIGNATIONS IN FIGURES

| Number | Description |
|---|---|
| 1 | High-bay warehouse |
| 11 | Storage levels |
| 12 | Storage location |
| 13 | Internal warehouse transport system |
| 14 | Warehouse aisles |
| 15 | Warehouse rows |
| 16 | High-bay rack |
| 2 | Level of transport |
| 21 | Accessing or leaving option |
| 3 | Transportation means |
| 31 | Truck |
| 32 | Autonomous driving tractor |
| 33 | Rail-bound transportation means |
| 4 | Storage goods |
| 5 | Transfer point |
| 6 | Travel path |
| 61 | Rail |

1.-16. (canceled)

17. A method for dynamically routing external transportation means (3) in a high-bay warehouse (1), the high-bay warehouse comprising
at least two storage levels (11) with a plurality of storage locations (12),
at least one level of transport (2) arranged below the at least two storage levels (11) with at least one access or leaving option (21) for an external transportation means (3),
at least one internal warehouse transport system (13) for transporting standardized storage goods (4) between two storage locations (12) or between the storage location (12) and a transfer point (5) by horizontal and/or vertical movements and for loading or unloading the standardized storage goods (4) onto the external transportation means (3) at the transfer point (5) by a vertical movement of the standardized storage goods (4),
wherein the at least one internal warehouse transport system (13) moves along warehouse aisles (14) arranged parallel to one another and has a plurality of transfer points (5) in the level of transport (2) and wherein each transfer point (5) can be described by an xy-coordinate system within the level of transport (2),
wherein each transfer point (5) in the level of transport (2) can be reached by the external transportation means (3) along a travel path (6) in the level of transport (2); and
wherein a dynamic determination of the travel paths (6) of the external transportation means (3) in the level of transport (2), a point in time for loading or unloading and an assignment of the transfer point (5) are adjusted depending on parameters relevant for operating the high-bay warehouse (1).

18. The method according to claim 17,
wherein an external transportation means (3) can be loaded or unloaded at more than thirty-two transfer points (5) in the level of transport (2).

19. The method according to claim 18,
wherein an external transportation means (3) can be loaded or unloaded at more than thirty-two transfer points (5) along a warehouse aisle (14) of an internal warehouse transport system (14) in the level of transport (2).

20. The method according to claim 19,
wherein the dynamic determination of the transfer point (5) within the warehouse aisle (14) of the internal warehouse transport system (13) is not limited by structural features for fixing the transfer point (5).

21. The method according to claim 17,
wherein the standardized storage goods (4) are 20-foot sea containers and/or 40-foot sea containers.

22. The method according to claim 17,
wherein at least two different types of external transportation means (3) selected from the group consisting of trucks (31), autonomously driving tractors (32), and rail-bound transportation means (33) traverse the level of transport (2) for loading or unloading the standardized storage goods (4).

23. The method according to claim 17,
wherein when determining the travel path (6) of the external transportation means (3) in the level of transport (2), an alignment of the standardized storage goods (4) on the external transportation means (3) is taken into account when loading the external transportation means (3) with the standardized storage goods (4).

24. The method according to claim 17,
wherein the dynamic determination of the travel path (6), the point in time for loading or unloading and/or the transfer point is carried out by an open-loop or closed-loop control system; and
wherein the open-loop or closed-loop control system has at least one algorithm that, based on previously defined target variables, determines and/or optimizes specifications for the parameters relevant for operating the high-bay warehouse, the travel path (6), the point in time for loading or unloading and/or the transfer point (5).

25. The method according to claim 24,
wherein the previously defined target variables are selected from the group consisting of a handling time, utilization of the high-bay warehouse, traffic volume, distribution of traffic flows, distribution of transportation means, utilization of traffic areas, utilization of the internal warehouse transport system, warehouse strategy, malfunction situations and/or maintenance.

26. The method according to claim 24,
wherein the parameters relevant for operating the high-bay warehouse are selected from the group consisting of traffic volume, distribution of traffic flows, distribution of transportation means, utilization of traffic areas, utilization of the internal warehouse transport system, warehouse strategy, malfunction situations, and maintenance.

27. The method according to claim 24,
wherein the open-loop or closed-loop control system exchanges data with the external transportation means (3), the data being selected from the group consisting of location, speed, travel path, a point in time for loading or unloading, and the transfer point (5).

28. The method according to claim 24,
wherein the open-loop or closed-loop control system uses interfaces to a control system of a seaport; and
wherein a data exchange of the previously defined target variables and/or the parameters relevant for operating the high-bay warehouse takes place between the systems.

29. The method according to claim 17,
wherein the xy-coordinate system for describing the transfer points (5) covers at least 90% of the level of transport.

30. The method according to claim 17,
wherein the travel path (6) of an external transportation means (3) to the transfer point (5) or away from the transfer point is described by a sequence of xy-coordinates.

31. The method according to claim 30,
wherein the travel path (6) of an external transportation means (3) to the transfer point (5) or away from the transfer point (5) is described by a sequence of xy-coordinates and points in time or time spans.

32. The method according to claim 17,
wherein switchable means are used within the level of transport (2) to indicate and/or restrict at least one travel path (6) for the external transportation means (30).
